(19) United States
(12) Patent Application Publication
(10) Pub. No.: US 2014/0164108 A1
(43) Pub. Date: Jun. 12, 2014

(54) Profiled Application Store Purchases Based On Operator Subscription

(71) Applicant: F-SECURE CORPORATION, Helsinki (FI)

(72) Inventors: Arto Saari, Vantaa (FI); Mira Sivonen, Helsinki (FI)

(73) Assignee: F-Secure Corporation, Helsinki (FI)

(21) Appl. No.: 13/709,151

(22) Filed: Dec. 10, 2012

(51) Int. Cl. G06Q 20/12

(52) U.S. Cl. CPC G06Q 20/123
USPC 705/14.53; 705/26.1

(57) ABSTRACT

A method comprises: providing a software application comprising at least two purchase options; publishing the software application to an online application store; and based on whether or not a user is a subscriber, selecting an individual one of the purchase options for displaying to the user.

### TECHNICAL FIELD

The invention relates generally to the field of software downloads from a common online portal such as applications from an application store.

### BACKGROUND

Online portals through which users of electronic devices (e.g., mobile devices) can shop among a wide variety of downloadable software are well known and sometimes referred to as application store environments. Some currently popular application store environments include, for example, Apple's AppStore, Google Play, and the Microsoft Windows Store and Marketplace. This downloadable software, which is also known as applications, is generally characterized as being relatively small in size, typically on the order of a few or tens of megabytes. Owner/operators of these conventional application store environments (hereinafter “application stores”) allow third parties (individual software/application developers and publishers) to make their software available as applications through the application store. For example, applications available through an application store may be provided by handset/smart phone vendors such as Samsung and Nokia; cellular service providers such as Verizon, Telefonica, and China Mobile; and by third parties such as Intel, Facebook, and Amazon.com. This has generally proven to be beneficial to both the owner/operators and the third party software/application publishers, as a wider variety of applications available through a single application store draws in a larger volume of customers, and the third party application developers and publishers have access to a pre-existing worldwide distribution platform at little expense.

Many applications are now developed for or by mobile network operators (MO). Some applications have been offered for sale as part of a larger service offering, i.e. as a package or bundle of applications included with a subscription to a mobile service or the like. For example, a bundle of applications may include security products such as antivirus, browser security, encryption, anti-spyware, and firewall software. To enable these bundled services to be offered in a typical application store, protocols based on the use of license keys, phone numbers, e-mail addresses, and the like have traditionally been employed to process payment requests and verify transaction validity. However, since application store policies have recently changed, the use of these protocols are no longer viable options for bundling services related to applications.

What is needed in the art is a model for profiling application store purchases in which services are bundled with one or more downloaded applications.

### SUMMARY

In accordance with one exemplary aspect of these teachings, there is a method comprising: providing a software application comprising at least two purchase options; publishing the software application to an online application store; and based on whether or not a user is a subscriber, selecting an individual one of the purchase options for displaying to the user.

In accordance with another exemplary aspect of these teachings, there is a computer readable memory that stores a set of executable instructions. In this aspect, the computer readable memory comprises code for providing a software application comprising at least two purchase options; code for publishing the software application to an online application store; and code for selecting an individual one of the purchase options for displaying to a user based on whether or not the user is a subscriber.

In accordance with a still further exemplary aspect of these teachings, there is an apparatus having at least one memory storing a set of computer executable instructions and at least one processor. The apparatus is caused to provide a software application comprising at least two purchase options; publish the software application to an online application store; and select an individual one of the purchase options for displaying to a user based on whether or not the user is a subscriber.

These and other aspects are detailed more particularly below.

### BRIEF DESCRIPTION OF THE DRAWINGS

FIG. 1 is a schematic overview of an application store in which several user devices are capable of shopping for an application, where the several user devices are subscribers to different operators.

FIG. 2 is a schematic block diagram of certain entities shown at FIG. 1 which are exemplary electronic entities/nodes/devices for practicing embodiments of the teachings herein.

FIG. 3 a conceptual overview of a sequence of providing in-application purchase options from a user's perspective.

FIG. 4 is a conceptual overview of one exemplary aspect of a profiling strategy involving a specific free application phase.

FIG. 5 is a schematic flow diagram illustrating the creation of an application offering for profiling by an operator.

### DETAILED DESCRIPTION

Bundled products and services for mobile devices are available from operators such as mobile operators (MO). These bundled products and services include combinations of applications that can be run on the mobile devices to provide various functions, such as security. The applications are generally provided as “native applications,” which are built using code specific and proprietary to the operating systems on which the application is based. For example, applications available from Apple's AppStore are typically built using code specific to Apple. Using a non-native application generally requires recoding of the software (e.g., an application built for an iPhone would likely involve a complete re-coding of the software for the application to work on a device running Google's Android operating system). Native applications are generally provided via “in-application purchasing,” which refers to the ability of the mobile device to facilitate the sale of products or services within a specific native application. In-application purchasing functionality has opened many new markets for the manufacturers of various mobile devices by, for example, allowing a user to purchase more storage space in backup applications, extend license periods, and the like.

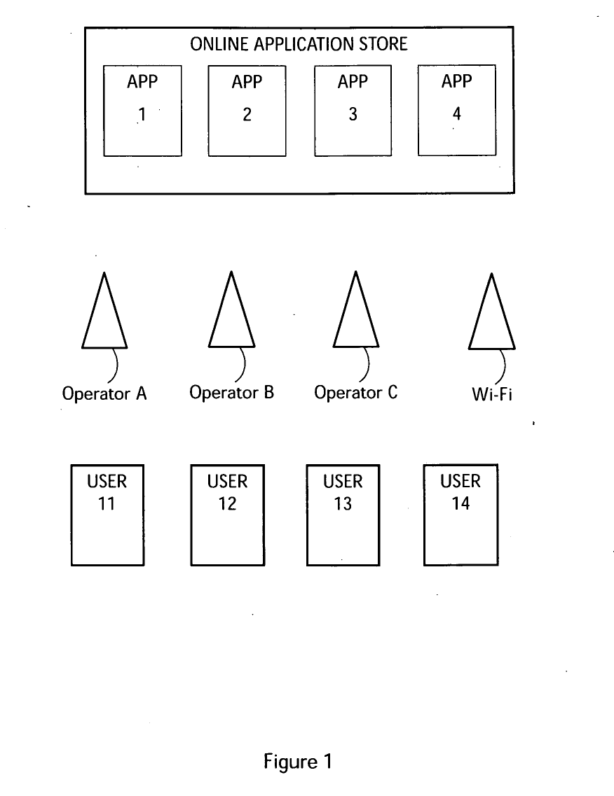

FIG. 1 is a schematic overview of an online application store which is explained according to an example embodiment of these teachings. The applications are published to the application store. As shown, four software applications are shown in the application store. These four software applications are Application 1, Application 2, Application 3, and Application 4. Any number of operators may provide users access to the applications published in the application store.

In the FIG. 1 example, user 11 is a customer of Operator A and in this example accesses the application store via operator A. Even if the user 11 is roaming and the actual connection to the application store goes through some roaming operator, the user 11 can be associated with operator A to which it subscribes through its IMSI (or more specifically, from codes extracted from the IMSI), as will be detailed below. Similarly user 12 is a subscriber of operator B and user 13 is a subscriber of operator C, so those customers are associated with those respective operators to the application purchase.

User 14 may or may not be a subscriber to one of the operators; at the time it accesses the application store it does so via a Wi-Fi connection. Regardless, user 14 can still be associated with the operator to which it subscribes if in fact it does have a subscription with an operator. Association of the individual customers/user devices with the individual operators can be done via the device's 15 digit International Mobile Subscriber Identity (IMSI) which carries the Mobile Country Code (MCC) and Mobile Network Code (MNC), which is detailed more particularly at co-owned US patent application publication 2011/0087757 (published on Apr. 14, 2011). This co-owned US patent application is hereby incorporated by reference in its entirety. Some operators or user devices may not provide the entire IMSI to querying entities and instead only provide the mobile country code (MCC) and mobile network code (MNC); these two codes alone are sufficient according to these teachings to identify the specific operator associated with a given user device that is requesting or that has downloaded and is now launching the relevant software application.

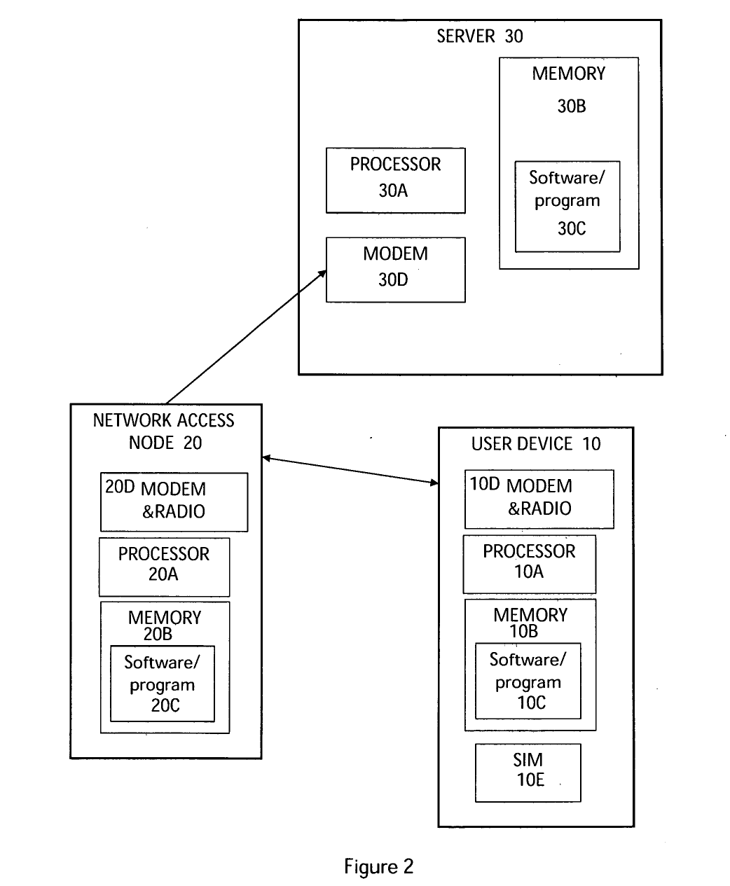

Before further detailing how an application may be profiled and presented differently depending upon whether or not a customer or user is a subscriber to a particular service or a non-subscriber, reference is made to FIG. 2 which details a high level schematic diagram of the involved electronic nodes. User device 10 represents any portable user radio device such as a smartphone, tablet computer, laptop computer, wearable computer, or the like, and includes at least one digital processor 10A, at least one computer readable memory 10B storing a set of computer executable programs 10C, a radio with modem 10D for two way wireless communication with a radio access network, and a subscriber identity module (SIM) 10E which carries the device's unique IMSI.

There is also shown at FIG. 2 a network access node 20 which also has its own at least one digital processor 20A, at least one computer readable memory 20B storing a set of computer executable programs 20C, and a radio with modem 20D for two way wireless communication with user devices such as the illustrated device 10.

The server 30 shown at FIG. 2 is in the position of the application store of FIG. 1. The server 30 includes at least one digital processor 30A, at least one computer readable memory 30B storing a set of computer executable programs 30C, and a modem 30D for two way communications over the Internet. Communications between the user device 10 and the server (in the position of the application store) pass through the network access node 20 and other nodes of the operator's radio access network, and then typically through a core network for routing to the Internet and the server 30.

The profiling of in-application purchases can provide a technical solution to offer bundled services related to applications by using the nodes, memory, and server of FIG. 2. The availability of any of the purchase options is dependent upon whether the user is a subscriber to a mobile service provided through a mobile operator (Operator A, Operator B, Operator C, etc.) through which the application store is accessed. This profiling involves the selection of purchase options from a vendor server. In one non-limiting example, providing profiled in-application purchase options can work in the following sequence:
The application calls a developer server (e.g., a vendor's server) to obtain a list of in-application purchase options for a user;
The developer server chooses in-application options and returns these options to the user;
The application shows the in-application options as a filtered in-application purchase list as returned from the server to the user; and
The user makes a purchase via the application store and unlocks any premium capabilities in the application.

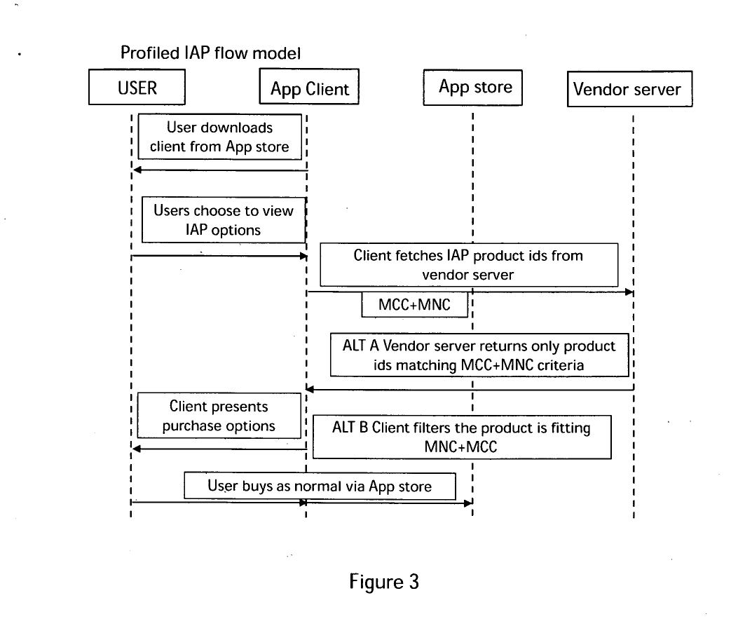

FIG. 3 illustrates one exemplary embodiment of a conceptual overview of the sequence of providing in-application purchase options. From the user's perspective, the first step in the sequence involves the selection of in-application options by sending a request to the developer server to retrieve a list of product identifiers. In selecting the in-application options, a device on which the user makes the selection is identified by the MCC and MNC, a status of the user based on whether the user is a subscriber or a non-subscriber is determined, and the user receives user bundle options based on the subscriber/non-subscriber status of the user (the subscribers of each respective operator receive a different list of options). Only a filtered list of options is displayed to the user. The options may be filtered at either the developer server or at the user device, as either the developer server or the user device may contain the logic necessary to perform the filtering operation. In-application purchase product identifiers associated with the bundle options are selected by the user, and the developer server returns a list of product information to the user via the application.

The application then sends a request to the application store to obtain information for the products. The application store returns the product information to the application, which uses the product information to make a display to the user. The user then makes a purchase by selecting an item from the display, and the application sends a payment request to the application store. The application store processes the payment and returns a completed transaction to the user via the application.

The application then retrieves the receipt data from the completed transaction and sends the receipt data to the developer server, which records the receipt data to establish an audit trail. The server then sends the receipt data to the application store to verify that the transaction was valid. The application store parses the receipt data and returns (to the developer server) both the receipt and an indication whether or not the receipt was valid. Processes by which the receipt data is parsed and the receipt deemed valid may vary with different application stores and may even be optional. The developer server then reads the returned receipt data to determine what the user purchased and delivers the purchased content to the application.

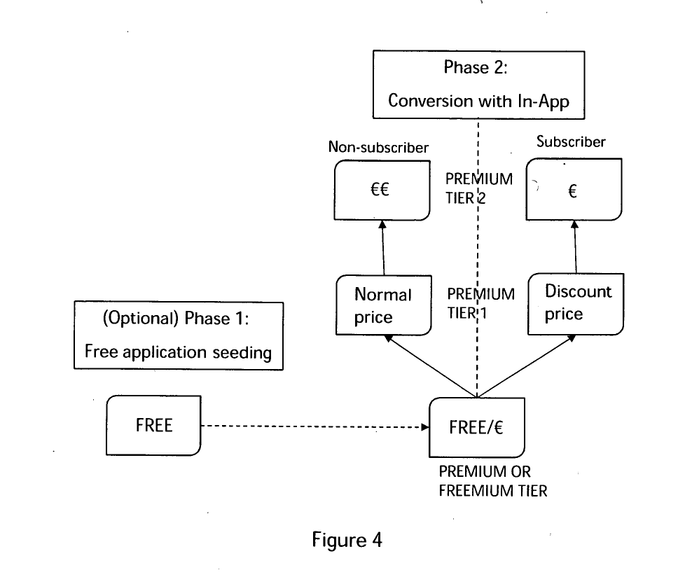

As shown in FIG. 4, one exemplary aspect of the profiling strategy is indicative of how profiled purchase options may be introduced to an already-published application. Such a strategy may involve an application offering having a specific free application phase during which no premium in-application purchase options are (yet) available. This allows for more time to market a product application in scenarios in which in-application capability will be provided with a delay. In this phase, when the user is a non-subscriber, the free application is a seeding application, and when the user is a subscriber, the free application is bundled with the subscriber's service. A license backend provider may order an identification for each activated user. In doing so, the vendor server is able to track which users have valid licenses. In this case, a new application is downloaded, so the identification is required by the vendor to associate the user with the new license.

When in-application purchase options become available, the user is then updated to a conversion phase that profiles the user based on the subscriber/non-subscriber status and sets the pricing. This conversion phase involves updating the user (irrespective of status) with in-application options to a “freemium” tier comprising a set of in-application purchase options. Once updated to the freemium tier, the profiling step is carried out based on the MCC and MNC. In this profiling step, the application is able to determine if the user is a subscriber to a particular operator. Options are provided, the options generally meaning that subscribers to a particular operator will be shown one listing and non-subscribers will be shown a different listing.

Some application stores do not allow listings of free in-application purchase options. In this case beyond the freemium tier, a “discounted” price is provided for users deemed to be subscribers (based on the MCC and MNC) and a “normal” price is provided for users profiled as non-subscribers. The discounted price can be set to a minimum price allowed by the application store. The option comprising this discounted price may also be compensated for as part of the subscriber/user's subscription bill. In other words, the operator may utilize the discount option to provide a business model in which products and services are bundled.

In either bundling the products and services for the subscriber at the discounted price or charging the non-subscribers the normal price, the freemium tier is converted to a premium tier. In converting to the premium tier, an upsell option may be made available for both subscribing users and non-subscribing users. This upsell option would allow either user to “upsell” to higher premium tiers with separate pricing options (i.e. discounted prices for subscribing users who upsell and normal prices for non-subscribing users who upsell). In doing so, the profiled purchase options are scaled beyond the initial purchase options.

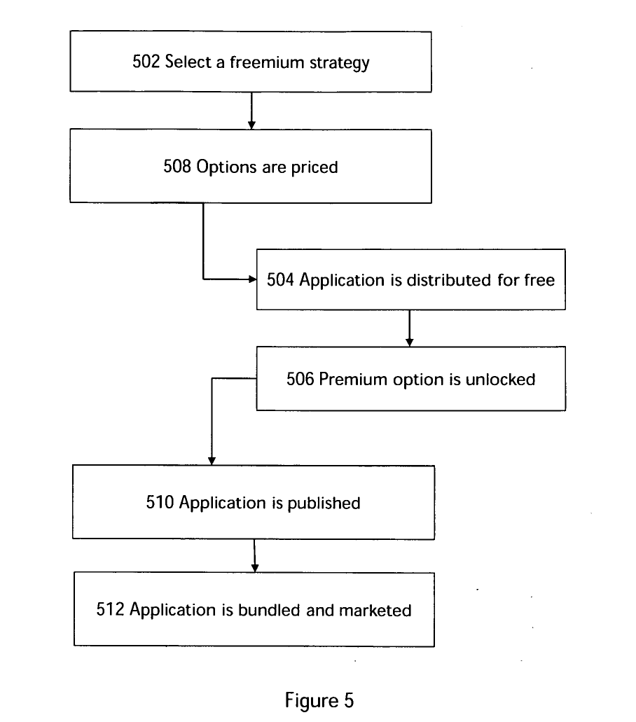

An operator (e.g., MO) may create an application offering for profiling as shown in the logical flow diagram as illustrated in FIG. 5. As shown at block 502, a first step in the creation of an in-application offering comprises selecting a freemium strategy. In order to utilize the selection capability, at least two levels of functionality are required. In the first level of functionality as shown at block 504, the application is distributed as a free application. In the second level of functionality as shown at block 506, a premium option (beyond the freemium tier) is unlocked by the in-application purchase. One variation of this strategy includes selling the application (the first level functionality) as a premium application (no profiled pricing) instead of distributing the application as free. Another variation of this strategy includes providing variants of functionality for non-subscribers (second level functionality A) and subscribers (second level functionality B). Still another variation involves adding further premium purchase options (for third- and subsequent level functionality). Blocks 504 and 506 may be modified as indicated by any of the foregoing variations.

In a second step as shown at block 508, the options are priced. This step comprises defining separate pricing per each purchase option with price differences between the non-subscriber and subscriber options.

In a third step as shown at block 510, the application is published to the application store.

In a fourth step as shown at block 512, the application is bundled with other applications and marketed for sale. This step involves marketing the application (e.g., to potential users) as part of a subscription bundle. A minimum fee to unlock the application may be charged.

It will be appreciated by the person of skill in the art that various modifications may be made to the above-described embodiments without departing from the scope of the invention. For example, the above description describes identifying the user using the MCC and MNC, but other user device identifiers may be used as well as other types of identifiers that are used or known by the user device such as the MSISCN number which identifies its operator network.

We claim:

1. A method, comprising:
providing a software application comprising at least two purchase options;
publishing the software application to an online application store; and
based on whether or not a user is a subscriber, selecting an individual one of the purchase options for displaying to the user.

2. The method according to claim 1, further comprising recording receipt data pertaining to a purchase option selected by the user in response to the individual one of the purchase options displayed to the user.

3. The method according to claim 2, further comprising verifying a validity of a transaction in which the individual one of the purchase options displayed to the user is selected.

4. The method according to claim 3, further comprising determining the selection of the user.

5. The method according to claim 4, further comprising delivering the selection to the user.

6. The method according to claim 1, wherein the software application comprising at least two purchase options is provided in response to offering a free application.

7. The method according to claim 1, wherein selecting an individual one of the purchase options for displaying to the user when the user is a subscriber comprises offering an option at a discounted price relative to a non-subscriber.

8. The method according to claim 1, wherein selecting an individual one of the purchase options for displaying to the user when the user is a subscriber comprises bundling an option to an operator bill of the subscriber.

9. A computer readable memory storing a set of executable instructions, the computer readable memory comprising:
code for providing a software application comprising at least two purchase options;
code for publishing the software application to an online application store; and
code for selecting an individual one of the purchase options for displaying to a user based on whether or not the user is a subscriber.

10. The computer readable memory according to claim 9, further comprising code for recording receipt data pertaining to a purchase option selected by the user in response to the individual one of the purchase options displayed to the user.

11. The computer readable memory according to claim 10, further comprising code for verifying a validity of a transaction upon selection of the individual one of the purchase options displayed to the user.

12. The computer readable memory according to claim 9, further comprising code for offering a free application in response to providing the software application comprising at least two purchase options.

13. The computer readable memory according to claim 9, further comprising code for offering an option at a discounted price relative to a non-subscriber when the user is a subscriber.

14. The computer readable memory according to claim 9, further comprising code for bundling an option to an operator bill of the subscriber when the user is a subscriber.

15. An apparatus comprising at least one memory storing a set of computer executable instructions and at least one processor, wherein the memory with the set of computer executable instructions is configured with the at least one processor to cause the apparatus to at least:
provide a software application comprising at least two purchase options;
publish the software application to an online application store; and
select an individual one of the purchase options for displaying to a user based on whether or not the user is a subscriber.

16. The apparatus of claim 15, wherein the memory is further configured to cause the apparatus to record receipt data pertaining to a purchase option selected by the user in response to the individual one of the purchase options displayed to the user.

17. The apparatus of claim 16, wherein the memory is further configured to cause the apparatus to verify a validity of a transaction upon selection of the individual one of the purchase options displayed to the user.

18. The apparatus of claim 15, wherein the memory is further configured to cause the apparatus to offer a free application in response to providing at least two purchase options.

19. The apparatus of claim 15, wherein the memory is further configured to cause the apparatus to offer an option at a discounted price relative to a non-subscriber when the user is a subscriber.

20. The apparatus of claim 15, wherein the memory is further configured to cause the apparatus to bundle an option to an operator bill of the subscriber when the user is a subscriber.
